(19) United States
(12) Patent Application Publication
(10) Pub. No.: US 2018/0176486 A1
(43) Pub. Date: Jun. 21, 2018

(54) ILLUMINATION DEVICE, IMAGING DEVICE, AND LENS

(71) Applicant: Panasonic Intellectual Property Management Co., Ltd., Osaka (JP)

(72) Inventors: Shinichi KADOWAKI, Hyogo (JP); Yosuke ASAI, Osaka (JP)

(21) Appl. No.: 15/899,940

(22) Filed: Feb. 20, 2018

Related U.S. Application Data
(63) Continuation of application No. PCT/JP2016/003659, filed on Aug. 9, 2016.

(30) Foreign Application Priority Data
Aug. 20, 2015 (JP) 2015-162838

(51) Int. Cl. H04N 5/33; F21V 14/02; G03B 15/05; F21V 5/04; F21V 13/04; H04N 5/232; H04N 5/225

(52) U.S. Cl. CPC H04N 5/33; F21V 14/02; G03B 15/05; F21Y 2115/10; F21V 13/04; H04N 5/23296; H04N 5/2256; F21V 5/04

(57) ABSTRACT

Illumination device (100) includes light source (110), lens (120) including first region (120a) having negative power and second region (120b) having positive power, and drive (130) that changes a relative distance between light source (110) and lens (120). The light of light source (110) passes through first region (120a) and second region (120b) even when the distance is changed to any distance by drive (130).

### BACKGROUND

### 1. Technical Field

The present disclosure relates to an illumination device in which a state of light irradiation is changeable, an imaging device that captures an image with illumination by an illumination device, and a lens that receives light emitted from a light source and changes the wave front.

### 2. Description of the Related Art

Conventionally, monitoring cameras that are a type of imaging device configured to capture images for crime prevention are provided in various places such as shopping streets, schools, and trains. Such a monitoring camera may be equipped with an infrared light illumination device that irradiates an object with infrared light. By providing an infrared light illumination device near a monitoring camera, it is possible to monitor and record an object at night or in a dark place by irradiating the imaging range of the monitoring camera with infrared light, and imaging the object irradiated with the infrared light.

PTL 1 discloses an illumination device that is mountable on a monitoring camera having a zoom function and in which an irradiation range is adjustable. The illumination device is configured of a light source, a first lens, and a second lens. Both the first lens and the second lens have positive refractive power. Light emitted from the light source passes through the second lens, and then passes through the first lens and illuminates an object. The second lens is movable along the optical axis with respect to the first lens fixed to the optical axis, whereby the irradiation range is adjustable. Further, the light source is moved along with the second lens. Thereby, it is possible to adjust the irradiation range of light radiated by the illumination device with respect to any imaging range.

### CITATION LIST

### Patent Literature

PTL 1: U.S. Pat. No. 8,885,095

### SUMMARY

The present disclosure provides a small-sized illumination device having a zoom function, capable of realizing light irradiation efficiently even though a wide angle end (wide end) and a narrow angle end are set in a wide range, with a simple configuration. The present disclosure also provides an imaging device that captures an image with irradiation of light emitted from the illumination device having a zoom function, and a lens suitable for the illumination device having a zoom function.

An illumination device according to the present disclosure includes a light source, an illumination optical system including a first region having negative power and a second region having positive power, and a zoom mechanism unit that changes a relative distance between the light source and the illumination optical system. Light of the light source passes through the first region and the second region even when the distance is changed to any distance by the zoom mechanism unit.

An illumination device according to another aspect of the present disclosure includes a plurality of light sources, a plurality of illumination optical systems, and a zoom mechanism unit. The plurality of illumination optical systems receive light emitted from the plurality of light sources, and output the light after changing the travel direction, concentration, or divergence of the light. The zoom mechanism unit is able to change the travel direction, concentration, or divergence of the light emitted from the illumination optical systems by changing relative distances between the plurality of light sources and the plurality of illumination optical systems. The plurality of light sources include a first light source and a second light source. The plurality of illumination optical systems include a first optical system and a second optical system. The illumination device satisfies a relationship of θW>θT. Here, it is assumed that when the zoom mechanism unit of the illumination device is set to a wide angle end, a position of the first light source, a position of the second light source, a position corresponding to the center of the first optical system, and a position corresponding to the center of the second optical system are represented by position WL1, position WL2, position WC1, and position WC2, respectively. It is assumed that when the zoom mechanism unit of the illumination device is set to a telephoto end, a position of the first light source, a position of the second light source, a position corresponding to the center of the first optical system, and a position corresponding to the center of the second optical system are represented by position TL1, position TL2, position TC1, and position TC2, respectively. It is assumed that a virtual axis linking position WL1 and position WC1 is represented by axis AW1. It is assumed that a virtual axis linking position WL2 and position WC2 is represented by axis AW2. It is assumed that a virtual axis linking position TL1 and position TC1 is represented by axis AT1. It is assumed that a virtual axis linking position TL2 and position TC2 is represented by axis AT2. It is assumed that an angle defined by axis AW1 and axis AW2 is represented by OW. It is assumed that an angle defined by axis AT1 and axis AT2 is represented by OT.

An imaging device according to the present disclosure includes the aforementioned illumination device, and a camera including an imaging optical system and an image sensor.

A lens according to the present disclosure includes a first region having negative power and a second region having positive power. The first region is formed in a center portion of a transmission surface of the lens. The second region is larger than the first region. When a focal distance of the first region is represented by f1 and a focal distance of the second region is represented by f2, |f2|≥|f1| is satisfied.

### BRIEF DESCRIPTION OF THE DRAWINGS

FIG. 1 is a diagram illustrating a schematic configuration of an illumination device at a narrow angle end according to a first exemplary embodiment;

FIG. 2 is a diagram illustrating a schematic configuration of an illumination device at a wide angle end according to the first exemplary embodiment;

FIG. 3A is a diagram illustrating a configuration of a lens of an illumination device according to the first exemplary embodiment;

FIG. 3B is a diagram illustrating a configuration of a lens of an illumination device according to the first exemplary embodiment;

FIG. 4A is a diagram illustrating a configuration of a lens of an illumination device according to a second exemplary embodiment;

FIG. 4B is a diagram illustrating a configuration of a lens of an illumination device according to the second exemplary embodiment;

FIG. 5 is a diagram schematically illustrating a configuration of an imaging device according to a third exemplary embodiment;

FIG. 6 is a diagram illustrating a configuration of a lens according to another exemplary embodiment;

FIG. 7 is a diagram illustrating a configuration of a lens according to another exemplary embodiment;

FIG. 8A is a diagram schematically illustrating a configuration of a lens and a light source of an illumination device according to a fourth exemplary embodiment;

FIG. 8B is a diagram schematically illustrating a configuration of a lens and a light source of an illumination device according to the fourth exemplary embodiment;

FIG. 9A is a diagram illustrating a configuration of a lens of an illumination device according to a fifth exemplary embodiment;

FIG. 9B is a diagram illustrating a configuration of a lens of an illumination device according to the fifth exemplary embodiment;

FIG. 10 is a diagram schematically illustrating a configuration of an imaging device according to a sixth exemplary embodiment; and

FIG. 11 is a diagram schematically illustrating a configuration of an imaging device according to a seventh exemplary embodiment.

### DETAILED DESCRIPTION

Hereinafter, exemplary embodiments will be described in detail with reference to the drawings as appropriate. However, detailed descriptions that are more than necessary may be omitted. For example, the detailed description of a well-known subject or repetitive description of the substantially same configuration is omitted in some cases. This is to avoid the following description from being unnecessarily redundant, and to facilitate understanding of those skilled in the art.

Note that the attached drawings and the following description are provided for those skilled in the art to fully understand the present disclosure, and are not intended to limit the subject matter as described in the appended claims.

### First Exemplary Embodiment

### [1-1. Configuration]

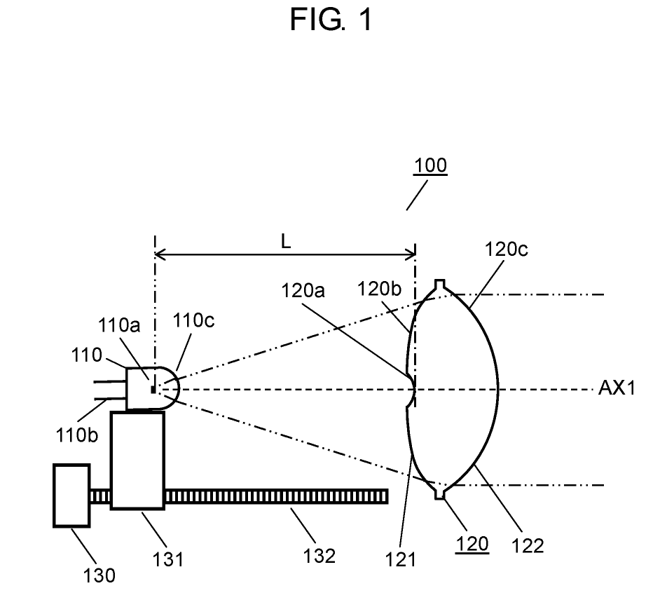

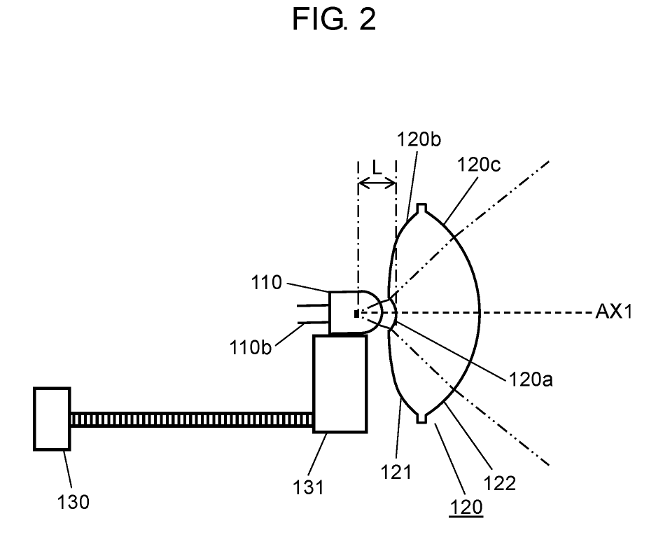

FIGS. 1 and 2 are diagrams illustrating an exemplary configuration of illumination device 100 according to a first exemplary embodiment. FIG. 1 is a diagram illustrating illumination device 100 at a narrow angle end where the illumination range is the narrowest. FIG. 2 is a diagram illustrating illumination device 100 at a wide angle end (wide end) where the illumination range is the widest.

Illumination device 100 includes light source 110, lens 120, and drive 130. Light source 110 includes light emitter 110a, connecting terminal 110b, and package 110c. Light emitter 110a is a semiconductor light source such as a light emitting diode (LED), for example. Package 110c seals light emitter 110a. Light emitter 110a is connected with a light emission control circuit, not illustrated, that controls a light emission state, via connecting terminal 110b. Light emitter 110a is sealed by package 110c.

Light emitter 110a radiates infrared light having a center wavelength of 850 nm. The area of the light emitting portion of light emitter 110a approximately ranges from 0.04 square mm to 25 square mm. In the present exemplary embodiment, one having 1 square mm is used.

Package 110c is in a hemispherical shape so as to have a function of a convex lens that converges emitted light from light emitter 110a. The radius of curvature of the hemispherical portion approximately ranges from 0.5 mm to 10 mm. In this example, the radius of curvature is 2.0 mm. It should be noted that the hemispherical portion may be in an aspherical shape, or in a planar shape not having a function of a convex lens, as required. By providing a region having a function of a convex lens near light emitter 110a in package 110c, it is possible to reduce the size of the optical system of the illumination device.

As a material of package 110c, generally used resin such as epoxy-based or silicon-based resin may be used. Further, in a case where high environmental performance is required, glass may be used. There is no restriction on the material, particularly. Any material can be used if it has quality of transmitting light emitted from light emitter 110a. In the present exemplary embodiment, epoxy-based resin is used.

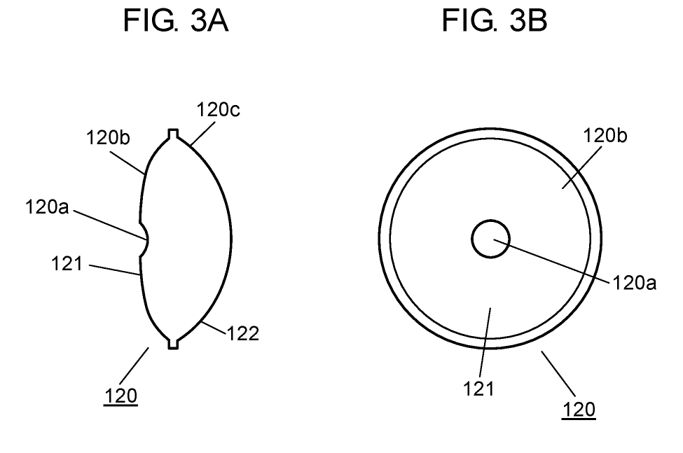

FIGS. 3A and 3B are diagrams illustrating lens 120 of the first exemplary embodiment. As illustrated in FIG. 3A, lens 120 includes first transmission surface 121 on which light from light source 110 is made incident, and second transmission surface 122 from which light is output.

FIG. 3B is a front view of lens 120 of the first exemplary embodiment. As illustrated in FIG. 3B, first transmission surface 121 includes first region 120a and second region 120b. First region 120a is formed in a center portion of first transmission surface 121, through which the optical axis of lens 120 passes. Second region 120b is formed around first region 120a on first transmission surface 121 except for first region 120a. The area of first region 120a approximately ranges from 1/10 to 1/1000 relative to the area of second region 120b.

Second transmission surface 122 has third region 120c throughout the surface.

First region 120a is a concave surface having negative power. Second region 120b and third region 120c are convex surfaces having positive power.

Focal distance f1 of first region 120a approximately ranges from −1 mm to −10 mm. Composite focal distance f23 of second region 120b and third region 120c approximately ranges from 10 mm to 1000 mm. In the first exemplary embodiment, focal distance f1 of first region 120a is −1.5 mm, and composite focal distance f23 of second region 120b and third region 120c is 30 mm.

The material of lens 120 may be any of commonly-used optical materials such as resin and glass, without any limitation particularly. In the present exemplary embodiment, acrylic resin is used.

As illustrated in FIG. 1, when the irradiation angle range is set to a narrow angle end, length L that is a distance from the light emission surface of light emitter 110a to the center of first region 120a of lens 120 becomes maximum. At this time, the length L is set to composite focal distance f23 of second region 120b and third region 120c. Thereby, illumination device 100 can also emit parallel light at the narrow angle end.

Illumination device 100 includes drive 130 that is a zoom mechanism for changing the length L between light emitter 110a and lens 120. Drive 130 includes holder 131 that holds the light source, and drive shaft 132 that extends in parallel with optical axis AX1. Drive 130 can be realized by any of various configurations including motors such as a piezoelectric motor and an ultrasonic motor and a configuration using an electromagnetic actuator. Any configuration is applicable without any limitation particularly. As drive shaft 132, a screw gear or the like may be used. The present exemplary embodiment is configured to move holder 131 in parallel with optical axis AX1 of the lens by rotating a screw gear with use of an electromagnetic motor. Light source 110 is fixed to holder 131, and is moved in the direction of optical axis AX1 with respect to lens 120.

The divergent light emitted from light emitter 110a of light source 110 passes through package 110c, and is made incident on lens 120 while remaining in a state of divergent light. At this time, the quantity of light made incident on first region 120a, of the light made incident on lens 120, approximately ranges from 1/10 to 1/1000, compared with the quantity of light made incident on second region 120b. Accordingly, most of the light emitted from second transmission surface 122 becomes almost parallel light. Therefore, it is possible to efficiently irradiate a distant area desired to be imaged, with a limited quantity of light emitted from light source 110.

Meanwhile, as illustrated in FIG. 2, in the case of setting the irradiation angle range to a wide angle end (wide end), length L between light emitter 110a and lens 120 becomes minimum. Length L in that case is set to a shorter distance than composite focal distance f23 of the focal distance of second region 120b and the focal distance of third region 120c.

In the case where the irradiation angle range is the wide angle end, the light emitted from light emitter 110a is made incident on first region 120a in a larger quantity relative to second region 120b. As most of the light emitted from light emitter 110a is made incident on first region 120a having negative power, the light becomes light having high divergence, whereby the light can be radiated in a wide angle range.

### [1-2. Effects]

By using lens 120 in which first region 120a is set to have an area approximately ranging from 1/10 to 1/1000 of the area of second region 120b, it is possible to realize generation of light having high divergence required when radiating light to a wide angle, and generation of light having low divergence or convergence required when radiating light to a distant object, by a small-sized simple optical system. This means that by configuring lens 120 so as to satisfy 1/10≥S1/S2≥ 1/1000 where the area of first region 120a is represented by S1 and the area of second region 120b is represented by S2, it is possible to realize generation of light having high divergence required when radiating light to a wide angle, and generation of light having low divergence or convergence required when radiating light to a distant object, by a small-sized simple optical system.

Further, in the case of radiating light of an intermediate angle to a wide angle, a peripheral light quantity ratio that is a light quantity ratio between the center portion and the peripheral portion is improved. Therefore, in the image captured by the imaging device, luminance unevenness is small in the entire image, and degradation due to S/N and saturation of the image is improved.

Further, in illumination device 100 of the first exemplary embodiment, assuming that the focal distance of first region 120a is represented by f1 and the composite focal distance of second region 120b and third region 120c is represented by f23, lens 120 has a relationship of |f23|≥|f1|. With the relationship of |f23|≥|f1|, the beam expansion effect of the concave lens becomes significant. Accordingly, in the setting for realizing illumination at a wide angle, a sufficiently wide area can be illuminated, while in the setting for realizing illumination at a narrow angle, it is easy to obtain a desired intensity distribution such that uniformity of light intensity in an illumination range can be maintained or intensity in the periphery is higher than that at the center.

### Second Exemplary Embodiment

### [2-1. Configuration]

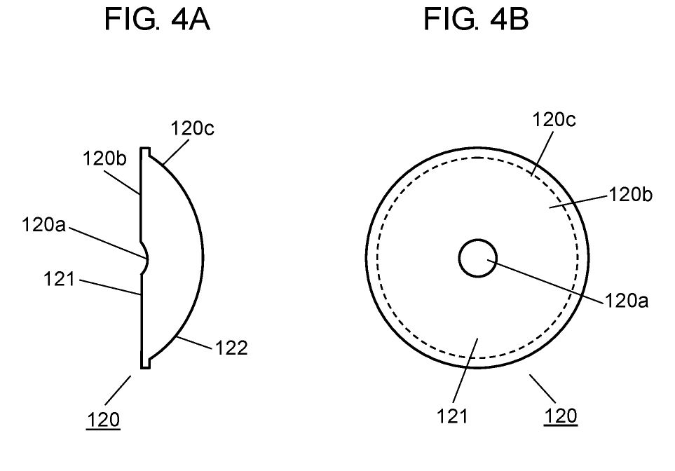

FIGS. 4A and 4B are diagrams schematically illustrating lens 120 of illumination device 100 according to the second exemplary embodiment. FIG. 4A is a side view of lens 120 of the second exemplary embodiment, and FIG. 4B is a diagram of lens 120 seen from the side of first transmission surface 121.

The illumination device of the second exemplary embodiment differs from the first exemplary embodiment only in lens 120. The other parts of the configuration are the same. Therefore, the description may be omitted.

In lens 120 of the second exemplary embodiment, second region 120b of lens 120 is flat. This is different from the first exemplary embodiment in which second region 120b of lens 120 has a convex surface of positive power.

In lens 120 of the second exemplary embodiment, first region 120a is a concave surface having negative power, and third region 120c is a convex surface having positive power. This is the same as the first exemplary embodiment.

The area of first region 120a of lens 120 in the present exemplary embodiment approximately ranges from 1/10 to 1/1000 relative to the area of second region 120b. Focal distance f1 of first region 120a approximately ranges from −1 mm to −10 mm, and focal distance f2 of second region 120b approximately ranges from 10 mm to 1000 mm. Further, when the absolute value of focal distance f1 of first region 120a is represented by f1a, lens 120 is configured to have a relationship of f2≥f1a.

### [2-1. Effects]

With second region 120b being in a flat surface, a workload for machining the lens into a curved surface can be reduced. In the case of fabricating a lens by forming it with use of a die, the cost of machining the die can be reduced. Therefore, it is possible to provide a less expensive illumination device.

Further, when lens 120 is fixed in the illumination device, second region 120b is used as a reference plane. Therefore, the lens can be mounted with high accuracy.

By using lens 120 in which first region 120a is set to have an area approximately ranging from 1/10 to 1/1000 of the area of second region 120b, it is possible to realize generation of light having high divergence required when radiating light to a wide angle, and generation of light having low divergence or convergence required when radiating light to a narrow angle, by a small-sized simple optical system. Further, in the case of radiating light of an intermediate angle to a wide angle, a peripheral light quantity ratio that is a light quantity ratio between the center portion and the peripheral portion is improved. Accordingly, in the image captured by the imaging device, luminance unevenness is small in the entire image, and degradation due to S/N and saturation of the image is improved.

Further, the aforementioned effect can be achieved remarkably when lens 120 has a relationship of f2≥f1a where the absolute value of focal distance f1 of first region 120a is represented by fla. This is also the same as the illumination device described in the first exemplary embodiment.

### Third Exemplary Embodiment

### [3-1. Configuration]

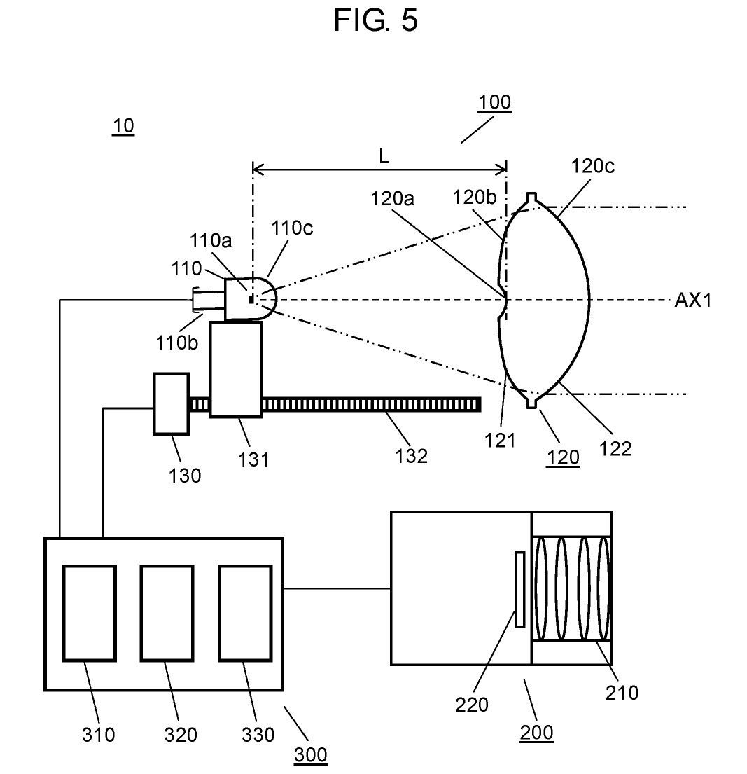

FIG. 5 is a schematic diagram illustrating imaging device 10 according to a third exemplary embodiment.

Imaging device 10 includes illumination device 100, camera 200 and controller 300.

As illumination device 100 has the same configuration as that of the first exemplary embodiment, the description thereof is omitted.

Camera 200 includes imaging lens 210 as an imaging optical system and image sensor 220, and captures an image of a predetermined range. Imaging lens 210 has a zoom function, and is able to adjust the imaging range.

Controller 300 includes light emission control circuit 310, drive control circuit 320, and camera control circuit 330. Light emission control circuit 310 controls the intensity of light emitted from light source 110 such that an image captured by camera 200 has appropriate brightness. As light emission control circuit 310, a general circuit that controls electric current or voltage, or a general circuit that controls electric current and voltage can be applied. Drive control circuit 320 receives a signal related to a zooming state of the camera from camera control circuit 330, and controls zooming of illumination device 100 such that a range to be imaged by camera 200 is irradiated with light appropriately. Camera control circuit 330 controls zooming of imaging lens 210 such that a range to be imaged becomes a desired range.

It should be noted that while illumination device 100 of the first exemplary embodiment is used in imaging device 10 of the third exemplary embodiment, any illumination device can be used in imaging device 10 if the illumination device has the characteristics of the present disclosure. Further, there is no limitation in the shape and the functions of camera 200. Any camera device such as one having a pan or tilt mechanism or one built in a doom shaped housing may be used.

### [3-2. Effects]

According to imaging device 10 of the third exemplary embodiment, the irradiation angle range of illumination device 100 can be changed according to the zooming state, that is, the angle of view, of camera 200. Accordingly, it is possible to capture a clear image all over the imaging range.

### Fourth Exemplary Embodiment

### [4-1. Configuration]

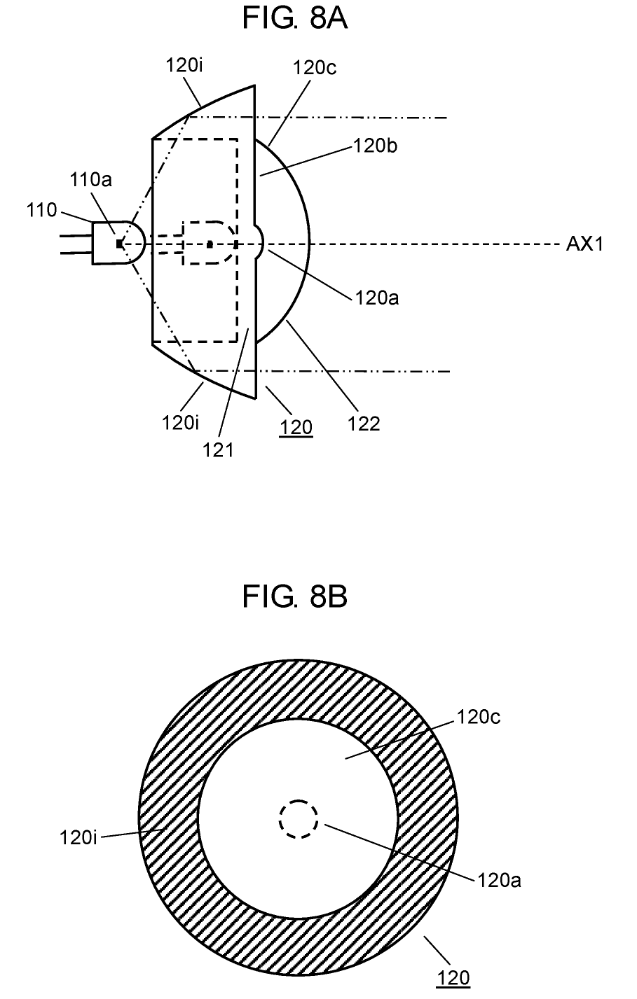

FIGS. 8A and 8B are diagrams schematically illustrating lens 120 and light source 110 of illumination device 100 according to a fourth exemplary embodiment.

FIG. 8A is a side view of lens 120 of the fourth exemplary embodiment, and FIG. 8B is a diagram of lens 120 seen from the side of second transmission surface 122.

The illumination device of the fourth exemplary embodiment differs from the illumination device of the first exemplary embodiment only in lens 120. The other parts of the configuration are the same. Therefore, the description may be omitted.

Lens 120 of the fourth exemplary embodiment has almost the same configuration as lens 120 of the second exemplary embodiment illustrated in FIGS. 4A and 4B, except that a reflector 120i is provided in the peripheral portion of lens 120. Reflector 120i is a concave surface mirror. The mirror in this exemplary embodiment means a reflective optical device. The method of realizing it includes those described below. Reflector 120i of lens 120 according to the fourth exemplary embodiment is a so-called total internal reflection (TIR) lens that reflects the entire light of light source 110.

Further, reflector 120i may be configured such that a general reflection film such as a metallic film or a dielectric multilayer film is formed on the surface thereof, without any limitation particularly.

Light source 110 shown by a solid line illustrates a light source at a position when the illumination range is set to a narrow angle, and light source 110 shown by a dotted line illustrates a light source at a position when the illumination range is set to a wide angle. This means that when light emitter 110 is at a relatively far position with respect to lens 120, the illumination range is a narrow angle, while when light emitter 110 is at a relatively near position, the illumination range is a wide angle.

When the illumination range is set to a narrow angle, a large quantity of the light emitted from light emitter 110a of light source 110 is directly made incident on first transmission surface 121 of lens 120, and then emitted from lens 120. At that time, light having a large angle with respect to optical axis AX1, of the light emitted from light emitter 110a, is not directly made incident on first transmission surface 121 of lens 120, but reflected by reflector 120i and then made incident on first transmission surface 121, and emitted from second transmission surface 122.

Meanwhile, when the illumination range is set to a wide angle, most of the light emitted from light emitter 110a of light source 110 is directly made incident on first transmission surface 121 without being reflected by reflector 120i, and emitted from second transmission surface 122.

### [4-2. Effects]

According to illumination device 100 of the fourth exemplary embodiment, light in which the angle is largely deviated from the optical axis, which is not utilized conventionally, can be utilized. Accordingly, the utilization efficiency of the light emitted from the light source becomes high, whereby the quantity of light that radiates a distant required range can be increased when the illumination range is set to a narrow angle. Therefore, it is possible to illuminate a more distant place clearly. Further, by using an imaging device having illumination device 100, it is possible to set an illumination range according to the angle of view of the imaging device.

### Fifth Exemplary Embodiment

### [5-1. Configuration]

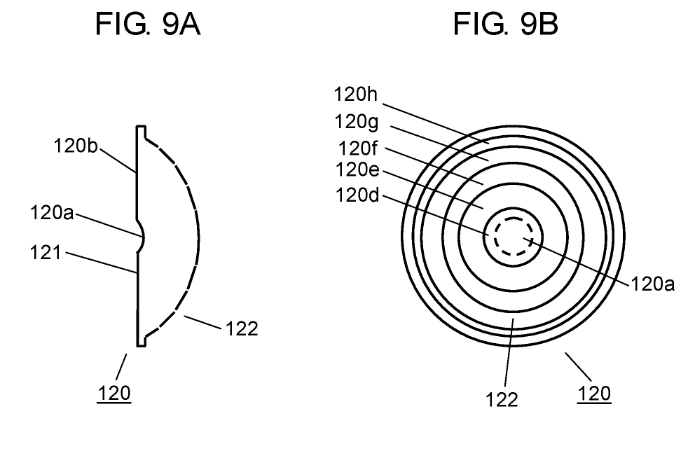

FIGS. 9A and 9B are diagrams schematically illustrating a lens of illumination device 100 according to a fifth exemplary embodiment.

FIG. 9A is a side view of lens 120 of the fifth exemplary embodiment, and FIG. 9B is a diagram of lens 120 seen from the side of second transmission surface 122.

The illumination device of the fifth exemplary embodiment differs from the illumination device of the first exemplary embodiment only in lens 120. The other parts of the configuration are the same. Therefore, the description may be omitted.

Lens 120 of the fifth exemplary embodiment has almost the same configuration as lens 120 of the second exemplary embodiment illustrated in FIGS. 4A and 4B. However, the configuration of transmission surface 122 is different.

Transmission surface 122 includes a plurality of regions 120d, 120e, 120f, 120g, and 120h. Each of regions 120d, 120e, 120f, 120g, and 120h is in a shape having lens power. The lens power of each of regions 120d, 120e, 120f, 120g, and 120h, that is, a focal distance, differs from one another.

In the light emitted from the light source, generally the intensity of the center portion of the optical axis is the highest, and the intensity is decreased as the angle is shifted from the optical axis. In the case of not using a homogenizer such as a fly-eye lens or a rod integrator, the light emitted from the illumination device has distribution such that the intensity is high in the center portion and is decreased toward the periphery. Consequently, an image captured by an imaging device is darker toward the periphery and the identification performance is deteriorated. However, with use of lens 120 of the present exemplary embodiment, a significant improvement can be made.

As an example, description will be given on the case where it is desired to improve the intensity distribution unevenness of light in an irradiation range, in a desired distance from 30 m to 100 m.

In lens 120 of the fifth exemplary embodiment, the positive power of region 120h is larger than the positive power of region 120g. The distance between the light source and lens 120 is set such that the light emitted from region 120h overlaps the range irradiated with the light emitted from region 120g. Thereby, the intensity in the peripheral portion of the irradiation range is higher than that in the case of using a general lens because the light from region 120g and the light from region 120h are overlapped with each other.

While description has been made regarding region 120g and region 120h for the sake of easy understanding, the same consideration is applicable to other regions.

FIGS. 9A and 9B illustrate the case where transmission surface 122 of lens 120 includes five regions 120d, 120e, 120f, 120g, and 120h. However, the number of regions and the lens power can be changed arbitrary in consideration of the intensity distribution of light to be radiated with respect to the distance.

For example, an imaging device itself often has characteristics that the brightness of an image is darker in the peripheral portion than in the center portion, due to the characteristics of the imaging lens. Accordingly, in consideration of such characteristics, an illumination device may be configured such that the light quantity is increased in the peripheral portion to thereby improve the image quality in the peripheral portion.

### [5-2. Effects]

According to the illumination device of the fifth exemplary embodiment, it is possible to improve uneven distribution of light intensity from the center to the peripheral portion of the irradiation range to thereby obtain a bright and clear image even in the peripheral portion.

Further, while description has been made on the case where transmission surface 122 includes a plurality of regions in the present exemplary embodiment, it is also acceptable that transmission surface 121 includes a plurality of regions 120a. In the case where a plurality of regions 120a are included, it is possible to set the irradiation range to a wider angle when setting the irradiation angle range to a wide angle end (wide end), and to significantly improve the intensity distribution.

### Sixth Exemplary Embodiment

### [6-1. Configuration]

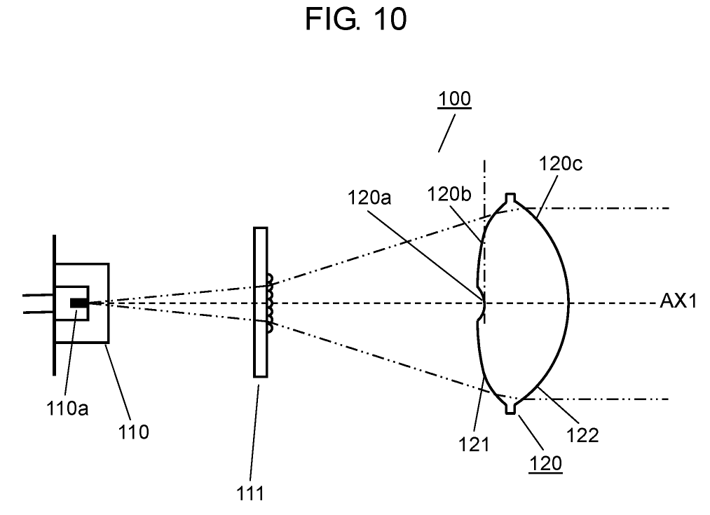

FIG. 10 is a schematic diagram illustrating illumination device 100 according to a sixth exemplary embodiment.

The illumination device of the sixth exemplary embodiment is different from the illumination device of the first exemplary embodiment in light source 110. Further, diffusion element 111 is added.

While light source 110 of the first exemplary embodiment is an LED, the sixth exemplary embodiment uses a semiconductor laser as light source 110. By using a semiconductor laser as light source 110, it is possible to illuminate a distant area more brightly than an LED.

In a semiconductor laser used as light source 110, appropriate wavelength and output are selected in consideration of some necessary conditions such as sensitivity and visibility of an imaging device. In this example, a semiconductor laser that emits light having a wavelength of 808 nm and an output of 10W is used.

A semiconductor laser can have a larger output from a smaller light emitting point, compared with an LED. Specifically, in the case of an LED, an optical output available when the size of the light emitting region is 1 mm×1 mm is about 1 W. On the other hand, in the case of a semiconductor laser, an optical output of about 10 W is available even when the size of the light emitting region is 2 μm×100 μm. At that time, an optical output per unit area in the light emitting region in the semiconductor laser is fifty thousand times that of the LED. Depending on the setting of a distance between light source 110 and lens 120, light emitted from lens 120 may be condensed to be in a very small size, that is, in a high light density. While the semiconductor laser in this example is expected to be of a Fabry-Pelrot type, it may be of a surface-emission type. In the case of a surface-emission type, physical light intensity per unit area is lower. However, in consideration of an angle of radiation, that is, etendue, optical light intensity per unit area may be as high as that of a Fabry-Pelrot type.

Diffusion element 111 diffuses light emitted from light emitter 110a of light source 110. The installation position of diffusion element 111 and a diffusion angle are determined according to an angle of radiation of light emitted from light emitter 110a and the optical specification of the illumination device. In this example, it is set that the equivalent size of a light emitting point is 1 mm square, and a diffusion angle given to incident light by diffusion element 111 is about 0.3 degrees. As diffusion element 111 is used, light emitted from lens 120 can be condensed only up to a certain large size, regardless of the distance between light source 110 and lens 120.

Although not illustrated in FIG. 10, when a zoom function is provided, the distance between light source 110 and diffusion element 111 may be fixed, and the distance between lens 120 and light source 110 may be changed.

### [6-2. Effects]

According to the illumination device of the sixth exemplary embodiment, even in the case of using a laser, light is not condensed to have a light density of a high level that may adversely affect the human body, in particular, eyes. Regarding light emitted from a laser or an LED, safe ranges are set by international standards or safety standards of individual countries. It is possible to provide an illumination device capable of illuminating a distant area brightly while satisfying the safe ranges.

While the case of using a semiconductor laser as a light source has been described, a diffusion element can be provided without any limitation to the case where the light source is a semiconductor laser. Effects of providing a diffusion element can be exhibited even in the case of using any light source.

### Seventh Exemplary Embodiment

### [7-1. Configuration]

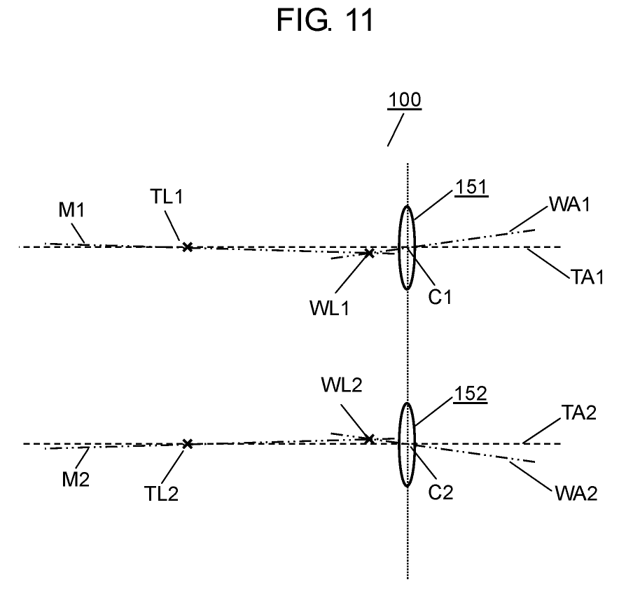

FIG. 11 is a schematic diagram illustrating illumination device 100 according to a seventh exemplary embodiment.

Illumination device 100 of the seventh exemplary embodiment has constituent elements similar to those of the illumination device of the first exemplary embodiment. An aspect that the illumination device of the seventh exemplary embodiment differs from the illumination device of the first exemplary embodiment is that while the illumination device of the first exemplary embodiment uses a pair of light source 110 and lens 120 that is an illumination optical system, the illumination device of the seventh exemplary embodiment uses two pairs of light sources, including first and second light sources, and lenses.

FIG. 11 schematically illustrates elements by limiting to those required for understanding the operation and the characteristics, in order to prevent the drawing from being complicated.

Each of lens 151 and lens 152 is the same as lens 120. However, as there are two lenses, they are denoted by different numerals.

In the present exemplary embodiment, while the first and second light sources are not illustrated, two light sources that are the same as light source 110 are used. This means that the first light source and the second light source each are configured of light source 110.

TL1 and TL2 represent positions of the two light sources when the irradiation angle range is set to a narrow angle end, and WL1 and WL2 represent positions of the two light sources when the irradiation angle range is set to a wide angle end (wide end).

Further, C1 and C2 represent the center positions of lens 151 and lens 152, respectively.

The illumination device of the first exemplary embodiment has a configuration that the lens is fixed at a specific position and the position of the light source is moved by the zoom mechanism unit. Accordingly, the irradiation range of illumination device 100 is the same even in the case of a narrow angle end and a wide angle end.

Further, TA1 represents a virtual axis linking position TL1 of the light source and center position C1 of lens 151 in a narrow angle end, TA2 represents a virtual axis linking position TL2 of the light source and center position C2 of lens 152, WA1 represents a virtual axis linking position WL1 of the light source and center position C1 of lens 151 in a wide angle end, and WA2 represents a virtual axis linking position WL2 of the light source and center position C2 of lens 152 in a wide angle end.

Further, M1 and M2 represent virtual axes linking a position of the light source when the irradiation angle range is set to a narrow angle end, and a position of the light source when the irradiation angle range is set to a wide angle end (wide end), respectively. This means that axes M1 and M2 show directions in which the light source is moved when the irradiation angle range is zoomed from the narrow angle end to the wide angle end (wide end).

In the illumination device 100 described in the present exemplary embodiment, axes TA1 and TA2 are set to be almost parallel to each other. This means that assuming that an angle defined by axes TA1 and TA2 is OT, OT is almost zero degrees.

Meanwhile, axes WA1 and WA2 are set to face different directions. This means that assuming that an angle defined by axis WA1 and axis WA2 is θW, θW is an angle larger than zero degrees but smaller than 180 degrees.

With such an arrangement, when the irradiation angle range is set to a narrow angle side, light radiated from two pairs of light sources and lenses overlap. Accordingly, it is possible to illuminate a distant necessary area brightly. Further, when the irradiation angle range is set to a wide angle side, it is possible to illuminate a wide angle range. Accordingly, it is possible to mitigate the fact that the peripheral portion of an image is dark.

In particular, when the aspect ratio of an image is not 1:1, a higher effect can be achieved by setting axes WA1 and WA2 to have different angles in the longitudinal direction of the image.

While the case of using two pairs of light sources and lenses has been described in this example, the number of pairs is not limited to two. The number may be increased as required. Further, axes TA1, TA2, WA1, and WA2 may also be set arbitrarily as required. Axes TA1 and TA2 are not necessarily in parallel. A significant effect can be achieved if a relationship of θW>θT is established.

### [7-2. Effects]

It is possible to provide an illumination device capable of irradiating a distant necessary region brightly when the irradiation angle range is set to a narrow angle side, and irradiating a wide angle range when the irradiation angle range is set to a wide angle side, to thereby be able to provide a bright clear image.

Further, in the illumination device of the present exemplary embodiment, there is not any limitation on the lenses to be used. The effect can be exhibited by using any lenses.

The above exemplary embodiments are an illustration of the technique of the present disclosure. Therefore, various changes, replacements, additions, or omissions may be made to the exemplary embodiments within the scope of claims or their equivalents.

### Other Exemplary Embodiments

In the first exemplary embodiment, the zoom mechanism is realized such that the position of lens 120 is fixed and light source 110 is movable in the direction of optical axis AX1. However, it is possible to fix the position of light source 110 and move lens 120. When light source 110 emits light of a high output, it is necessary to provide a radiator plate or a fan. In that case, the radiation efficiency can be enhanced when the position of light source 110 is fixed, and the driving load by drive 130 is low. Therefore, a small-sized illumination device can be provided.

Further, light source 110 is not limited to an LED. It may be a laser such as a semiconductor laser. A laser has smaller etendue compared with an LED. Accordingly, light emitted from the light source can be utilized efficiently even though the optical system having a zoom function is smaller.

Further, light source 110 is not limited to a semiconductor light source. Any light source such as a discharge lamp or an incandescent lamp is applicable as required.

Further, while the center wavelength of light emitted from light source 110 is assumed to be 850 nm, the wavelength is not limited particularly. A light source of any wavelength can be used. When a light source that emits light having a center wavelength of 940 nm, that is infrared light having a wavelength longer than 850 nm, is used, human eyes do not recognize that light is emitted from the light source. Accordingly, this is suitable when light irradiation is not desired to be known. On the contrary, in the case where there is no problem in irradiation, a light source that emits light of a visible wavelength region may be used.

Further, by allowing package 110c to have a convex lens function, it is possible to utilize the light emitted from light source 110 efficiently with a smaller lens 120. Accordingly, an extremely small-sized illumination device can be provided. In the case of using an LED as a light source, the light emitted from the LED generally has a Lambertian characteristic. Accordingly, the full width at half maximum of the light spreading angle is about 120 degrees. When a component in a convex lens shape having positive power is disposed near the light source, the spreading angle of light emitted from the light source can be narrowed. Accordingly, it is possible to utilize the light emitted from the light source efficiently even though the lens constituting the illumination optical system is smaller. While package 110c has a convex lens function in this example, package 110c may not have a convex lens function. Instead, it is possible to provide another element having a convex lens function besides package 110c.

Further, when the size of the optical system is not limited particularly, an element having a convex lens function may not be disposed near the light source.

An element having a concave lens function may be disposed near the light source. This is particularly effective when a semiconductor laser is used as a light source. In general, the full wide at half maximum of the spreading angle of light emitted from a semiconductor laser approximately ranges from 5 degrees to 30 degrees in the case of Fabry-Perot type, and approximately ranges from zero degrees to 20 degrees in the case of surface emission type. As the spreading angle of light emitted from a light source can be increased by disposing an element having a concave lens function near the semiconductor laser that is a light source, a sufficiently large range can be illuminated when wide angle illumination is set. In the case where there is no element in a concave lens shape having negative power immediately near the light source, in order to perform zoom operation to change the illumination range, it is necessary to largely move a relative distance between the illumination optical system and the light source. When an element having a concave lens function with negative power is provided immediately near the light source, the moving distance can be reduced, whereby a small-sized illumination device can be realized.

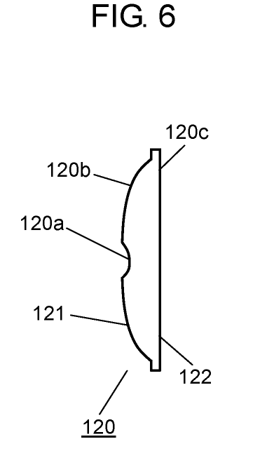

As illustrated in FIG. 6, lens 120 may include first region 120a having a concave lens function and second region 120b having a convex lens function on first transmission surface 121, and third region 120c on second transmission surface 122 may be flat. Illumination device 100 can be configured by using lens 120 illustrated in FIG. 6, instead of lens 120 of the first exemplary embodiment.

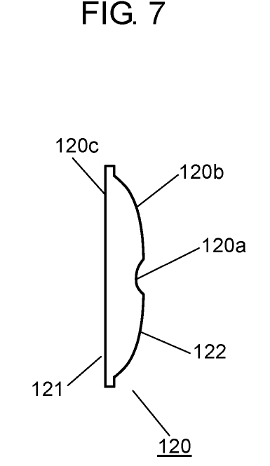

Further, as illustrated in FIG. 7, lens 120 may be configured such that first transmission surface 121 includes flat third region 120c, and second transmission surface 122 includes first region 120a having a concave lens function and second region 120b having a convex lens function. Illumination device 100 can be configured by using lens 120 illustrated in FIG. 7, instead of lens 120 of the first exemplary embodiment.

The light emitted from light source 110 is made incident from first transmission surface 121 side, and then emitted from second transmission surface 122.

In any lens 120 used in illumination device 100 of the present disclosure, a region having a concave lens function may be formed on either a transmission surface, of the side close to the light source, on which the light emitted from the light source is made incident, or a transmission surface, of the side far from the light source, from which the light emitted from the light source is emitted.

Further, a region having a concave lens function and a region having a convex lens function may be in a spherical shape having a single curvature, or in an aspherical shape. With a region in an aspherical shape, it is possible to improve uniformity of light to be irradiated and to regulate the irradiation angle range to be wider.

Further, each surface of lens 120 may be in an anamorphic form. With a region in an anamorphic form, when the aspect ratio of a range to be imaged is not 1:1, it is possible to radiate light appropriately with a high light utilization efficiency according to the ratio. When a region is in an anamorphic form, an average focal distance in each region can be designed as a focal distance of the region.

Further, each surface of lens 120 may have any configuration such as a Fresnel lens or a diffraction lens, if a concave lens function and a convex lens function can be provided.

Further, lens 120 may be an optical element other than a lens if a light traveling direction or concentration or divergence of light from the light source can be changed.

Further, the number of light source 110 and lens 120, constituting illumination device 100, is not limited to one each. A plurality of light sources 110 and lenses 120 may be used in order to obtain a required light quantity in a desired range.

Further, a portion of the outer appearance of lens 120 may be cut to remove an unnecessary portion. In the case of using a plurality of light sources and lenses, by cutting a portion of the outer appearance of the lenses, the light sources and lenses 120 can be disposed efficiently. Therefore, it is possible to provide a bright illumination device even in a small size.

Further, lens 120 used in the illumination device of the present disclosure may take various forms other than lens 120 described in the first exemplary embodiment and lens 120 described in the second exemplary embodiment. The effects achievable by the illumination device of the present disclosure can be exhibited if lens 120 has a region having a concave lens function in the center portion of the lens, and a region having a convex lens function on the outer peripheral portion of the region having the concave lens function or on a transmission surface different from the transmission surface on which the region having a concave lens function is formed, and if the region having the convex lens function is larger than the region having the concave lens function.

An illumination device of the present disclosure is applicable to illumination devices in general. With the illumination device of the present disclosure, a zoom optical system can be simple and small, light having less intensity unevenness can be radiated to all over the imaging range, and illumination can be made at night or to a dark place.

Further, the illumination device of the present disclosure is applicable to imaging devices in general such as a monitoring camera and a Nightvision camera that are required to capture a clear image through illumination at night or to a dark place.

What is claimed is:

1. An illumination device comprising:
a light source;
an illumination optical system including a first region having negative power and a second region having positive power; and
a zoom mechanism unit that changes a relative distance between the light source and the illumination optical system,
wherein light of the light source passes through the first region and the second region even when the relative distance is changed to any distance by the zoom mechanism unit.

2. The illumination device according to claim 1,
wherein the illumination optical system includes the first region in a center portion including an optical axis, and
wherein the second region is larger than the first region.

3. The illumination device according to claim 2, wherein the second region is formed on a same surface as a surface on which the first region is formed and around the first region.

4. The illumination device according to claim 2, wherein the second region is formed on a surface different from a surface on which the first region is formed.

5. The illumination device according to claim 1, wherein the illumination optical system satisfies |f2|≥|f1|, where f1 represents a focal distance of the first region and f2 represents a focal distance of the second region.

6. The illumination device according to claim 1, wherein the illumination optical system satisfies 1/10≥S1/S2≥ 1/1000, where S1 represents an area of the first region and S2 represents an area of the second region.

7. The illumination device according to claim 1, wherein at least one region of the first region and the second region is in an anamorphic form.

8. An imaging device comprising:
the illumination device according to claim 1; and
a camera including an imaging optical system and an image sensor.

9. The imaging device according to claim 8,
wherein the camera has a zoom function, and
wherein the illumination device changes the relative distance between the light source and the illumination optical system according to a state of zoom of the camera.

10. A lens comprising: a first region having negative power and a second region having positive power,
wherein the first region is formed in a center portion of the lens,
wherein the second region is larger than the first region, and
wherein the lens satisfies |f2|≥|f1|, where f1 represents a focal distance of the first region and f2 represents a focal distance of the second region.

11. The lens according to claim 10, wherein the second region is located on a same surface as a surface on which the first region is formed and around the first region.

12. The lens according to claim 10, wherein the second region is formed on a surface different from a surface on which the first region is formed.

13. The lens according to claim 10, wherein the lens satisfies 1/10≥S1/S2≥ 1/1000, where S1 represents an area of the first region, and S2 represents an area of the second region.

14. The lens according to claim 11, wherein at least one region of the first region and the second region is in an anamorphic form.

15. The lens according to claim 11,
wherein the lens includes a third region having positive power,
wherein the third region is formed on a surface different from a surface on which the first region is formed,
wherein the third region is larger than the first region, and
wherein the lens satisfies |f23|≥|f1|, where f1 represents a focal distance of the first region and f23 represents a composite focal distance of the second region and the third region.

16. The lens according to claim 15, wherein at least one region of the first region, the second region, and the third region is in an anamorphic form.

17. The lens according to claim 10, further comprising a reflection surface in a peripheral portion of the lens.

18. The lens according to claim 10, wherein the first region or the second region includes a plurality of regions having different focuses.

19. An illumination device comprising:
a plurality of light sources including a first light source and a second light source that emit light;
a plurality of illumination optical systems including a first optical system and a second optical system that output the light emitted from the plurality of light sources, by changing a travel direction, concentration, or divergence of the light; and
a zoom mechanism unit that changes relative distances between the plurality of light sources and the plurality of illumination optical systems,
wherein assuming that when the illumination device is set to a wide angle end, a position of the first light source, a position of the second light source, a position corresponding to center of the first optical system, and a position corresponding to center of the second optical system are represented by position WL1, position WL2, position C1, and position C2, respectively,
that when the zoom mechanism unit of the illumination device is set to a telephoto end, a position of the first light source, a position of the second light source, a position corresponding to center of the first optical system, and a position corresponding to center of the second optical system are represented by position TL1, position TL2, position TC1, and position TC2, respectively,
that a virtual axis linking position WL1 and position C1 is represented by axis AW1,
that a virtual axis linking position WL2 and position C2 is represented by axis AW2,
that a virtual axis linking position TL1 and position TC1 is represented by axis AT1,
that a virtual axis linking position TL2 and position TC2 is represented by axis AT2,
that an angle defined by axis AW1 and axis AW2 is represented by θW, and
that an angle defined by axis AT1 and axis AT2 is represented by θT,
a relationship of θW>θT is satisfied.
